(19) United States
(12) Patent Application Publication
(10) Pub. No.: US 2025/0086502 A1
(43) Pub. Date: Mar. 13, 2025

(54) CLASSIFYING DATA OBJECTS USING NEIGHBORHOOD REPRESENTATIONS

(71) Applicant: Google LLC, Mountain View, CA (US)

(72) Inventors: Oleg Golubitsky, Guelph (CA); Dake He, Waterloo (CA)

(21) Appl. No.: 18/560,756

(22) PCT Filed: Dec. 30, 2022
(86) PCT No.: PCT/US2022/054397

§ 371 Date: Nov. 14, 2023

(51) Int. Cl. G06N 20/00

(52) U.S. Cl. CPC G06N 20/00

(57) ABSTRACT

Methods, systems, and apparatus, including computer programs encoded on computer storage media, for classifying data objects. One of the methods includes maintaining a dataset including reference data objects that each have one or more labels, one or more features, or both; receiving a request to add, to the dataset, a new data object that has one or more features but is missing one or more labels; selecting N neighbor data objects based on similarity scores of the neighbor data objects with respect to the new data object; generating a neighborhood feature vector for the new data object; processing the neighborhood feature vector using a machine learning model to predict the one or more labels for the new data object; and updating the dataset to include the new data object and to associate the one or more predicted labels with the new data object.

### TECHNICAL FIELD

This specification relates to machine learning and classifying data objects using neural networks.

### BACKGROUND

A machine learning model receives input and generates an output based on the received input and on values of the parameters of the model. For example, machine learning models may receive an image and generate a score for each of a set of classes, with the score for a given class representing a probability that the image contains an image of an object that belongs to the class.

The machine learning model may be composed of, e.g., a single level of linear or non-linear operations or may be a deep network, e.g., a machine learning model that is composed of multiple levels, one or more of which may be layers of non-linear operations. An example of a deep network is a neural network with one or more hidden layers.

### SUMMARY

This specification describes a data object classification system that receives a data object and generates a classification for the data object. Specifically, the system accesses a dataset that stores reference data objects in association with known categories and uses the known categories of similar reference data objects that are in a neighborhood of the data object to generate the classification for the data object.

In general, one innovative aspect of the subject matter described in this specification can be embodied in methods including the operations of maintaining a dataset including reference data objects that each have one or more labels, one or more features, or both, wherein each label for a reference data object defines a respective category of the reference data object and each feature for the reference data object describes a characteristic of the reference data object; receiving a request to add, to the dataset, a new data object that (i) has one or more features but (ii) is missing one or more labels; selecting, from the reference data objects, N neighbor data objects based on similarity scores of the neighbor data objects with respect to the new data object, wherein the similarity score for each neighbor data object is determined based on the one or more features of the new data object and the one or more features of the neighbor data object, where N is a natural number equal to or greater than one; generating a neighborhood feature vector for the new data object using, for each neighbor data object in the N neighbor data objects, (i) the one or more labels of the neighbor data object and (ii) the similarity score of the neighbor data to the new data object; processing the neighborhood feature vector using a machine learning model to predict the one or more labels that are missing for the new data object; and updating the dataset to include the new data object and to associate the one or more predicted labels with the new data object.

Other implementations of this aspect include corresponding apparatus, systems, and computer programs, configured to perform the aspects of the methods, encoded on computer storage devices. These and other implementations can each optionally include one or more of the following features.

In some aspects, maintaining the dataset including reference data objects includes maintaining data describing a heterogeneous graph including nodes connected by edges, each node corresponding to a different one of the reference data objects in the reference data objects, each edge representing a relationship between two nodes connected by the edge.

In some aspects, maintaining the dataset including reference data objects includes maintaining the reference data objects and their associated labels and features in a relational dataset.

In some aspects, the operations further include determining the similarity score for each neighbor data object with respect to the new data object based on one of: Euclidean distance or cosine similarity in an embedding space.

In some aspects, the operations further include determining the similarity score for each neighbor data object with respect to the new data object based on one of: a pointwise mutual information (PMI) score or a bipartite score.

In some aspects, the machine learning model includes one of: a neural network, a logistic regression model, a support vector machine (SVM), or a decision tree or random forest model.

In some aspects, generating the neighborhood feature vector for the new data object includes determining a concatenation of respective similarity scores of a subset of the N neighbor data objects having a particular category among the respective categories defined by their one or more labels.

In some aspects, the subset of the N neighbor data objects include neighbor data objects that each have a first label, e.g., a positive label, that defines a trusted category.

In some aspects, the subset of the N neighbor data objects include neighbor data objects that each have a second label, e.g., a negative label, that defines a non-trusted category.

As used herein, a data object having a positive label defining a trusted category refers to a data object corresponding to a category that satisfies a trustworthy condition (e.g., that satisfies a trustworthiness threshold). A data object having a positive label may become “allow listed,” such that the data object is permitted to be used, e.g., manipulated or otherwise processed, by a computer system. A data object having a negative label defining a non-trusted category refers to a data object corresponding to a category that does not satisfy the trustworthy condition (e.g., that does not satisfy the trustworthiness threshold). A non-trusted data object may become “block listed,” such that the data object may not permitted to be used by a computer system.

In some aspects, each data object represents an image, video, an audio, text, or a web page.

In some aspects, a value of N is dependent on a total number of the labels that each reference data object has.

Particular embodiments of the subject matter described in this specification can be implemented so as to realize one or more of the following advantages. By configuring a data object classification system to predict labels for an input data object based on a neighborhood representation of the input data object determined from a dataset of reference data objects maintained by the system, both the accuracy of the label prediction and the inference speed of prediction process can be improved. In particular, label prediction can be performed in real time even on dynamic data objects that are frequently being modified over time, and on a very initial stage within the entire life cycle of a data object (e.g., within seconds or milliseconds from which the data object becomes available). The label prediction can also be performed using fewer memory resources than other approaches because processing high-dimensional categorical features that are typically stored as sparse high-dimensional vectors using a 1-hot encoding can be avoided. Instead, labels can be predicted based on neighborhood representations maintained in the form of dense vectors that can be efficiently stored and retrieved from memory.

The neighborhood representation of the input data object, which can be generated by encoding similarity scores (relative to the input data object), known label and feature information, and so on of a subset of neighbor reference data objects of the input data object that are selected from the dataset into a structured dense vector format, is a data efficient and informative representation that facilitates the classification of the input data object by using any of a variety of known classifiers as well as other downstream tasks that involve the processing of the representation. Moreover, the interpretability of the data object classification system is improved because the generation process of the neighborhood representation can be tracked and thus the context of the classification can be more easily examined. In the realm of many real-world production environments, this enables someone to understand how a particular label was assigned to the input data object, e.g., how did the system predict that a web page is a phishing or malicious web page, or how did the system predict that an image contains prohibited content, thereby making it possible to address potential trust issues that manifest as a concern about the decision that led to a particular outcome.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example data object classification system.

FIG. 2 illustrates an example a heterogeneous graph that represent reference data objects.

FIG. 3 is a flow diagram of an example process for generating one or more labels for an input data object.

FIG. 4 is a block diagram of an example computer system that can be used to perform operations described.

Like reference numbers and designations in the various drawings indicate like elements.

### DETAILED DESCRIPTION

This specification describes a data object classification system that receives a data object and generates a classification for the data object.

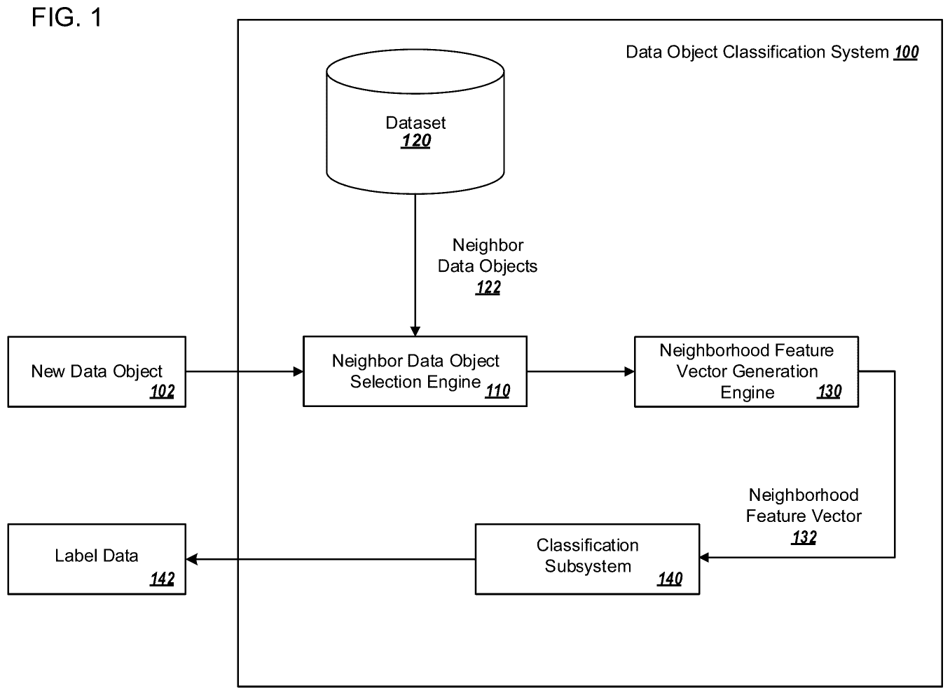

FIG. 1 shows an example data object classification system 100. The data object classification system 100 is an example of a system implemented as computer programs on one or more computers in one or more locations, in which the systems, components, and techniques described below can be implemented.

The data object classification system 100 generates label data for given data objects, e.g., label data 142 for a new data object 102. Each data object has one or more features that each describe a respective characteristic, attribute, or property of the data object. The label data for a given data object identifies one or more category labels for the data object. Each of the category labels is a label for a category in a discrete (e.g., finite) set of possible categories to which the data object classification system 100 has determined that the data object belongs. Generally, a category label for a given category is a term that identifies or otherwise describes the category. For example, the category for an image can include a topic of content depicted by the image or objects detected in the image.

The data object classification system 100 can be configured to generate label data for any of a variety of data objects, e.g., any kind of data object that can be classified as belonging to one or more categories, each of which is associated with a respective label. Once generated, the data object classification system 100 can use the label data in any of a variety of ways.

For example, if the data objects are images, the data object classification system 100 may be a visual recognition system that determines whether an input image includes images of objects that belong to object categories from a predetermined set of object categories. In this example, the label data for a given input image identifies one or more labels for the input image, with each label labeling a respective object category to which an object pictured in the image belongs. In this example, the features of a data object can include pixels intensity values, edges, corners, ridges, interest points, and color histograms of an image, possible metadata associated with the image, and so on.

As another example, if the data objects are videos or portions of videos, the data object classification system 100 may be a video classification system that determines to what topic or topics an input video or video portion relates. In this example, the label data for a given video or video portion identifies one or more labels for the video or video portion, with each label identifying a respective topic to which the video or video portion relates. In this example, the features of a data object can include intensity values for the pixels of each frame of the video, visual features of the frames, and possible metadata associated with the video.

As another example, if the data objects are audio data, the data object classification system 100 may be a speech recognition system that determines, for a given spoken utterance, the term or terms that the utterance represents. In this example, the label data for a given utterance identifies one or more labels, with each label being a term represented by the given utterance. In this example, the features of a data object can include time-domain and frequency-domain features, e.g., energy envelope and distribution, frequency content, harmonicity, pitch, and so on.

As another example, if the data objects are text data, the data object classification system 100 may be a text classification system that determines to what topic or topics an input text segment relates. In this example, the label data for a given text segment identifies one or more labels for the text segment, with each label identifying a respective topic to which the text or text segment relates. In this example, the features of a data object can include text features obtained through any suitable natural language processing technique, e.g., lexical analysis, pattern recognition, sentiment analysis, and so on.

As another example, if the data objects are web pages, the data object classification system 100 may be a web page classification system that determines to which categories a given web page (or contents of the given web page) belongs. In this example, the label data for a given web page identifies one or more labels, with each label identifying respective category to which the web page belongs. In this example, the features of a data object can include URL features (e.g., host name, usage, subdomain, top level domain, URL length, and HTTPS existence), domain features (e.g., domain registration duration, age of domain, domain name owner, associated domain registrar, website traffic, and DNS records), website code features (e.g., presence of website forwarding and pop-up window usage), website content features (e.g., hyperlinks to target website, hyperlinks to non-target websites, media content, and text input fields). website visitor features (e.g., IP address, visit time, and session duration).

Appropriate actions may then be taken by the system on the data object in these examples, e.g., providing the labels to a user of the system (e.g., as a response to a request/search query submitted by the user), forwarding the data object, the labels, or both to another system for additional processing, flagging for deeper review in a human investigation process, using the labeled data object in a map/navigation context, and so on.

The data object classification system 100 includes a neighbor data object selection engine 110, a dataset of reference data objects 120, a neighborhood feature vector generation engine 130, and a classification subsystem 140.

The dataset of reference data objects 120 can be a labeled data object database (or other appropriate data structure) which stores reference data objects in association with the known label data for the reference data objects, e.g., in data storage devices and/or cloud-based storage. The dataset of reference data objects 120 can be any data store that is suitable for storing multiple reference data objects and their associated labels and features. In some implementations, the dataset 120 can be a relational database having a multi-dimensional structure, where each feature of a data object is stored in a cell of the relational database defined by a row and a column. In the example where each data object represents a web page, the relational database can store relationships between the features of the web pages having different labels. For example, the relational database can store relationships between geographic locations for web pages having a particular label, the contents included in the web pages having the particular label, the layouts of the web pages having the particular label, and the functionalities available on the web pages having the particular label, and/or combinations of these.

In some implementations, the dataset 120 can be a heterogeneous graph that includes multiple nodes and edges connecting the nodes, where the nodes and edges both have heterogeneous types. The heterogeneous graph can be a representation of relationships between the reference data objects, and the heterogeneous graph can be stored in one or more data stores. Each node in the heterogeneous graph represents a different reference data object (with the same type of nodes representing the same type of reference data objects), and pairs of reference data objects in the heterogeneous graph are connected by edges that indicate a relationship between the two reference data objects represented by the pair of nodes.

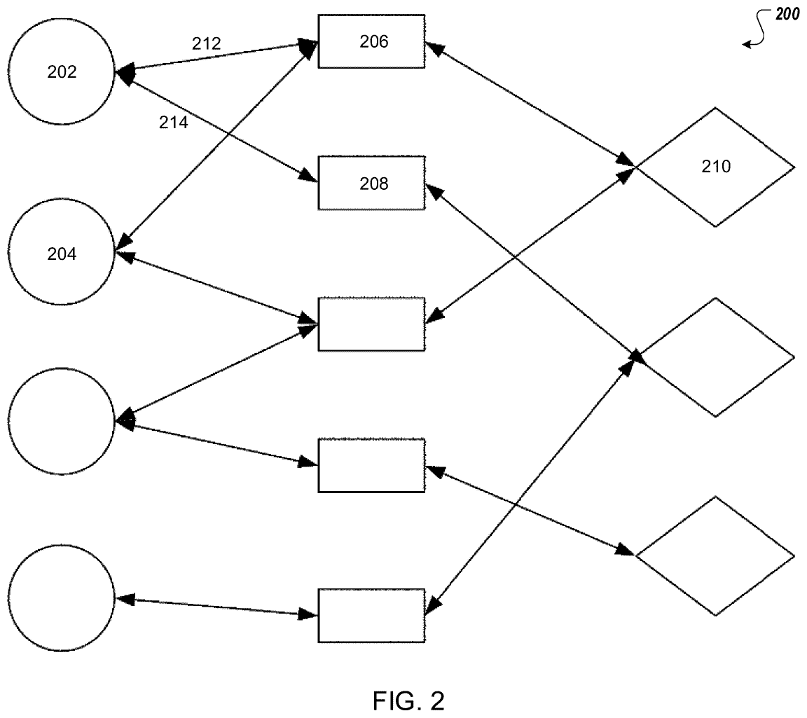

FIG. 2 illustrates an example a heterogeneous graph 200 that represents reference data objects. The heterogeneous graph 200 identifies relationships between the reference data objects.

For example, the heterogeneous graph 200 includes nodes 202 and 204 representing first reference data objects, nodes 206 and 208 representing second reference data objects, and node 210 representing a third reference data object. The first, second, and third reference data objects can be of different types from each other. For example, nodes 202 and 204 can each represent a respective web domain, whereas nodes 206 and 208 can each represent a respective IP address. An edge that connects a pair of nodes indicates that there exists some measure of relevance between the reference data objects represented by the pair of connected nodes. For example, node 202 and node 206 are connected by an edge 212, indicating that the web domain represented by node 202 is hosted at the IP address represented by node 206.

Referring back to FIG. 1, in order to classify the new data object 102, the neighbor data object selection engine 110 selects a proper subset of neighbor data objects 122 from the dataset of reference data objects 120 based on a similarity score of each of the neighbor data objects 122 with respect to the new data object 102. A proper subset includes at least one data object in the dataset, but less than all of the data objects in the data set. That is, the neighbor data object selection engine 110 selects, as neighbor data objects 122, a relatively small number of reference data objects from the dataset that are most similar to the new data object 102. While a large number of, e.g., one million, ten million, one billion, or more, reference data objects may be maintained by the system 100 in the dataset 120, only a small number of them may actually need to be selected, e.g., only the top 50, 100, or 200 neighbor data objects that have the highest similarity scores or that satisfy a similarity threshold may need to be selected.

For example, the neighbor data object selection engine 110 can compute the similarity score by evaluating a vector-space-based similarity measure, e.g., a pairwise cosine similarity or Euclidean distance, of vectors or some other embeddings (i.e., structured representations in an embedding space) that represent the features of a neighbor data object 122 and the features of the new data object 102, respectively. As another example, the neighbor data object selection engine 110 can compute the similarity score by evaluating a graph-based distance measure between a pair of nodes in a heterogeneous graph or another information graph that represents the neighbor data object 122 and the new data object 102, respectively. Other similarity scores can be used.

The neighborhood feature vector generation engine 130 uses the selected subset of neighbor data objects 122 to generate one or more neighborhood feature vectors 132 of the new data object 102. In particular, the neighborhood feature vector generation engine 130 can use (i) one or more labels, (ii) the similarity score (relative to the new data object), or both (i) and (ii) of each neighbor data object 122 in the selected subset to generate each neighborhood feature vector 132.

The classification subsystem 140 receives the one or more neighborhood feature vectors 132 and processes the neighborhood feature vectors 132 to generate the label data 142 which identifies one or more category labels for the new data object 102. The classification subsystem 140 can include one or more machine learning models. Each classification machine learning model can be configured as a neural network model (e.g., a Multi-layer Perceptron model), a Naïve Bayes model, a Support Vector Machine model, a linear regression model, a logistic regression model, or a k-nearest neighbor model, to name just a few examples. Each model can be configured to process a model input including the neighborhood feature vector 132 in accordance with model parameters to generate a model output that includes a respective classification score for each of a predetermined set of possible categories of the new data object 102.

In some implementations where multiple classification machine learning models are included, each model can correspond to a respective partition (or subset) of the predetermined set of possible categories for the new data object 102. In some of these implementations, each model can process a different neighborhood feature vector 132 than each other model. Each model can be configured to, for each category in the respective partition, generate a respective classification score for the category. For example, assume the new data object 102 represents an image that has a total of four possible categories (each representing a possible object that may be present in the image) including: (i) a horse, (ii) a dog, (iii) a golden retriever, and (iv) a German shepherd, a first partition may include the more generic categories, i.e., category (i) and category (ii), and a second partition may include the more specific categories, i.e., category (iii) and category (iv). In this example, a first model included in the classification subsystem 140 can generate a respective classification score for each of category (i) and category (ii), while a second model included in the classification subsystem 140 can generate a respective classification score for each of category (iii) and category (iv), with the classification score for a given category representing the likelihood that the new data object 102 belongs to the given category. Within each partition, the classification subsystem 140 can then select the category with the higher (or highest) classification score as a category as determined by the classification subsystem for the new data object 102.

Once the label data 142 for the new data object 102 is generated, the data object classification system 100 can store the new data object 102 in the dataset of reference data objects 120. For example, the system can store the new data object in association with the label data for the new data object, e.g., in association with data identifying the labels that have been generated for the new data object. In some implementations, instead of or in addition to storing the new data object in the dataset of reference data objects 120, the data object classification system 100 can associate the label or labels with the new data object and provide the labeled data object for use for some immediate purpose. For example, the system can provide the labels to another system, e.g., a client device on which an application has requested for connection to a web page, which then uses the labels to approve or reject the connection request of the application.

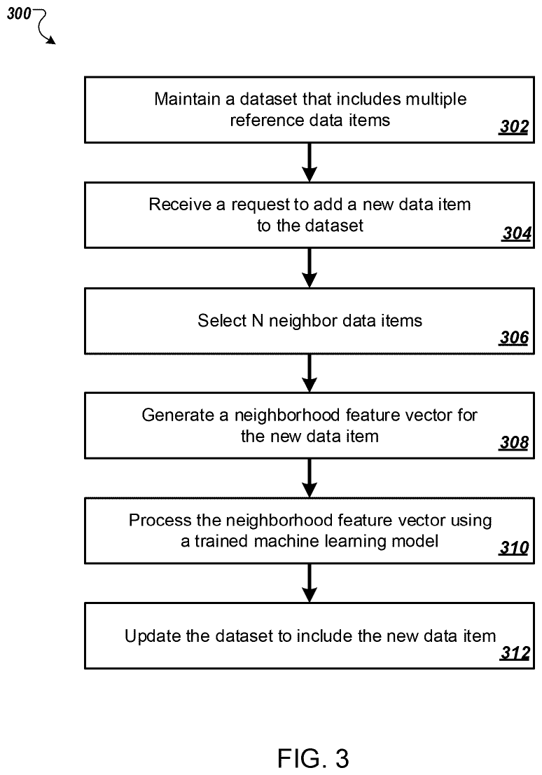

FIG. 3 is a flow diagram of an example process 300 for generating one or more labels for an input data object. For convenience, the process 300 will be described as being performed by a system of one or more computers located in one or more locations. For example, a data object classification system, e.g., the data object classification system 100 of FIG. 1, appropriately programmed, can perform the process 300.

The system maintains a dataset that includes multiple reference data objects (step 302). The dataset is a labeled dataset that stores the reference data objects in association with data specifying one or more labels and one or more features of the data object. Each label for a reference data object in the dataset defines a respective known category of the reference data object. Each feature for the reference data object describes a characteristic of the reference data object.

The label data, feature data, or both for the reference data objects in the dataset can be made available to the system in any of a variety of ways. For example, the label data can be provided by a user of the system that is either the same as or different from another user who provided the feature data of the reference data objects. As another example, the feature data can be provided by a data collection system while the label data may be determined by another data classification system from the feature data. As another example, the label data can previously be determined by the system itself from the available feature data of the reference data objects.

As a particular example for illustration, each data object may represent a web page, and the one or more labels of the each data object may be selected from one or more of: (i) activity status labels (including, e.g., an active status label, a dormant status label, an expired status label, etc.) that define an activity status of the web page, (ii) legitimacy status labels (including, e.g., a phishing label, a trusted label, etc.) that define a legitimacy status of the web pages, and so on, while the one or more features of the each data object may describe one or more of: (i) a geographic location of the web page (e.g., defined by IP address or area code), (ii) content included in the web page, (iii) a layout of the web page, (iv) a functionality of the web page, (v) an age of the web page or the number of visits received by the web page, and so on.

The system receives a request to add a new data object to the dataset (step 304). The new data object can have one or more features but can be missing one or more labels. The request can be submitted by a user of the system, e.g., over a wired or wireless network. The request can reference the new data object, for example by way of providing data that identifies the new data object and that defines the one or more features of the new data object through a user interface made available by the system. Unlike the feature data which is made available to the system when the request to add the new data object is received, the one or more labels are typically not specified by request and are thus not readily available to the system. In order to determine the one or more missing labels of the new data object, the system accesses reference data objects stored in the dataset maintained by the system.

Specifically, the system selects, from the multiple reference data objects, N neighbor data objects based on similarity scores of the neighbor data objects with respect to the new data object (step 306). In particular, the system determines the similarity score for each reference data object in the dataset based on (i) one or more features of the new data object and (ii) one or more features of the reference data object. Once determined, the system sorts these similarity scores in descending order of their score values and correspondingly selects N reference data objects (as the N neighbor data objects) having the highest score values, where N is a predetermined natural number equal to or greater than one, e.g., ten, fifty, a hundred, etc. In some cases, N can have a predetermined fixed value, while in other cases, the exact value of N can be dependent on the total number of features that each reference data object has; thus the system generally selects more neighbor data objects in cases where each reference data object has more labels that define a larger number of categories of the reference data object.

Depending on how the reference data objects are stored in the dataset, the system can compute the similarity scores in any of a variety of ways. For example, the similarity score can be computed by evaluating a vector-space-based similarity measure, e.g., a pairwise cosine similarity or Euclidean distance, of vectors or some other embeddings that represent the features of a reference data object and the features of the new data object, respectively. As another example, the similarity score can be computed by evaluating a graph-based distance measure between a pair of nodes in an information graph that represents the reference data object and the new data object, respectively.

As one specific example, in implementations where the dataset maintains the multiple reference data objects in a heterogeneous graph format, the system can compute the similarity scores as pointwise mutual information (PMI) similarity scores by using the techniques described in commonly owned PCT Patent Application No. WO2021173114A1, which is herein incorporated by reference. As another specific example, in these implementations the system can alternatively compute the similarity scores as bipartite similarity scores by using the techniques described in commonly owned U.S. Pat. No. 10,152,557B2, which is herein incorporated by reference.

The system generates one or more neighborhood feature vectors for the new data object (step 308). In particular, the system uses (i) the one or more labels of the neighbor data object, (ii) the similarity score of the neighbor data to the new data object of each neighbor data object in the N neighbor data objects, or both (i) and (ii) to generate each neighborhood feature vector.

For example, the system can generate a neighborhood feature vector by determining a concatenation of the similarity scores of some or all of the N neighbor data objects, a concatenation of the labels of some or all of the N neighbor data objects, or both. As another example, the system can generate a neighborhood feature vector by determining a concatenation of other values, e.g., binary values or other numeric values, that can be derived from the similarity scores, labels, or both.

In a particular example, the system can generate the neighborhood feature vector by determining a concatenation of respective similarity scores of a subset of the N neighbor data objects having one or more particular categories among all of the respective categories defined by their one or more labels. In this particular example, the neighborhood feature vector can be computed as:

$${x}_{1} {x}_{2} … {x}_{L} {x}_{L + 1} … {x}_{K L} {x}_{K L + 1} … {x}_{K L + N} ,$$

where K<<N, and L can be any natural number no greater than the total number of labels of each data object, and where
x₁=the highest similarity score among all similarity scores of the N neighbor data objects that have a first particular label;
x_{L}=the highest similarity score among all similarity scores of the N neighbor data objects that have a L-th particular label;
x_{KL}=the K-th highest similarity score among all similarity scores of the N neighbor data objects that have the L-th particular label;
x_{KL+1}=the highest similarity score among all similarity scores of the N neighbor data objects;
x_{KL+N}=the N-th highest similarity score among all similarity scores of the N neighbor data objects.

The system processes the one or more neighborhood feature vectors using one or more machine learning models to predict the one or more labels that are missing for the new data object (step 310). Since the neighborhood feature vectors generated at step 308 are each a vector representation that contain information about or otherwise derived from the similarity scores and labels of the N neighbor data objects of the new data object, using the neighborhood feature vectors can facilitate faster and more accurate identification of the one or more missing labels of the new data object.

Generally, each of the one or more machine learning models is a model that has been configured to generate classification scores for new data object. In some implementations where multiple machine learning model are included, different models can process different model inputs to generate different classification scores. For example, a first model can process a first model input that includes a first neighborhood feature vector in accordance with first model parameters to generate a respective classification score for each category in a first partition of a predetermined set of categories, a second model can process a second model input that includes a second neighborhood feature vector of the new data object in accordance with second model parameters to generate to generate a respective classification score for each category in a second partition of the predetermined set of categories. The system can select each of the one or more labels based on the classification scores, e.g., by selecting a label corresponding to the highest classification score (either in the predetermined set of categories, or in a partition of the predetermined set of categories) or a label corresponding to a classification score that exceeds a predetermined threshold value.

Once the label data for the new data object is generated, the system updates the dataset to include the new data object and to associate the one or more predicted labels with the new data object (step 312). That is, the system adds the new data object (as a reference data object) to the dataset by adding data that specifies (i) the one or more features defined by the received request and (ii) the one or more labels predicted by the system from the neighborhood feature vector to the dataset.

The process 300 can be performed for each input data object to generate one or more labels for the input data object. The input data object can be a data object for which the desired label data, i.e., the labels that should be generated by the system for the data object. are not known. The system can also perform the process 300 on input data objects in a set of training data, i.e., a set of input data objects for which the labels that should be predicted by the system is known, in order to train the system, i.e., to determine trained values for the parameters of the machine learning model(s) that are configured to process the neighborhood feature vectors. In some implementations, the process 300 can be performed repeatedly on input data objects selected from a set of training data as part of a conventional machine learning training technique, e.g., a gradient descent with backpropagation training technique, to train the model.

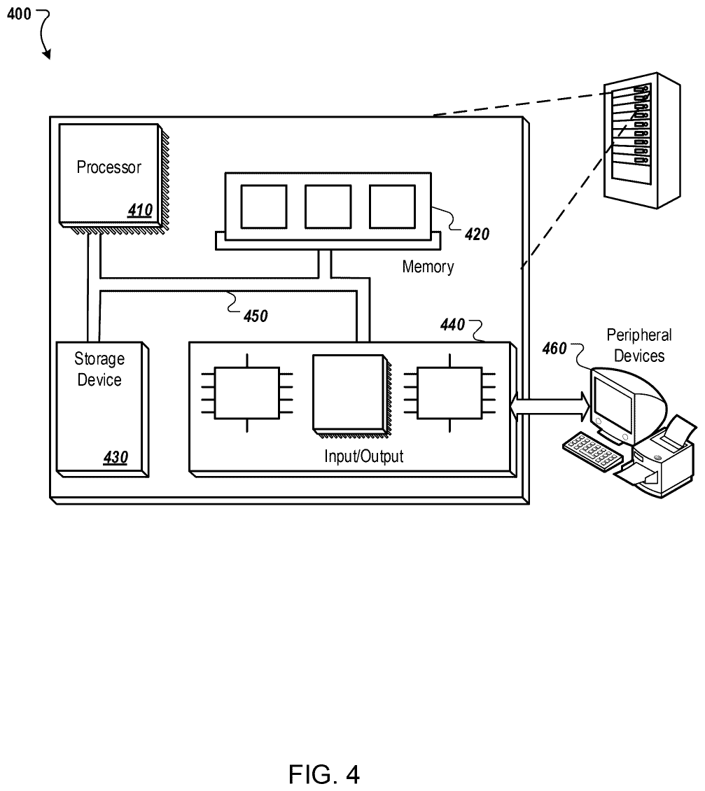

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 370. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
maintaining a dataset comprising a plurality of reference data objects that each have one or more labels, one or more features, or both, wherein each label for a reference data object defines a respective category of the reference data object and each feature for the reference data object describes a characteristic of the reference data object;
receiving a request to add, to the dataset, a new data object that (i) has one or more features but (ii) is missing one or more labels;
selecting, from the plurality of reference data objects, N neighbor data objects based on similarity scores of the neighbor data objects with respect to the new data object, wherein the similarity score for each neighbor data object is determined based on the one or more features of the new data object and the one or more features of the neighbor data object, where Nis a natural number equal to or greater than one;
generating a neighborhood feature vector for the new data object using, for each neighbor data object in the N neighbor data objects, (i) the one or more labels of the neighbor data object and (ii) the similarity score of the neighbor data to the new data object;
processing the neighborhood feature vector using a machine learning model to predict the one or more labels that are missing for the new data object; and
updating the dataset to include the new data object and to associate the one or more predicted labels with the new data object.

2. The method of claim 1, wherein maintaining the dataset comprising a plurality of reference data objects comprises maintaining data describing a heterogeneous graph comprising a plurality of nodes connected by edges, each node corresponding to a different one of the reference data objects in the plurality of reference data objects, each edge representing a relationship between two nodes connected by the edge.

3. The method of claim 1, wherein maintaining the dataset comprising a plurality of reference data objects comprises maintaining the plurality of reference data objects and their associated labels and features in a relational dataset.

4. The method of claim 1, further comprising determining the similarity score for each neighbor data object with respect to the new data object based on one of: Euclidean distance or cosine similarity in an embedding space.

5. The method of claim 1, further comprising determining the similarity score for each neighbor data object with respect to the new data object based on one of: a pointwise mutual information (PMI) score or a bipartite score.

6. The method of claim 1, wherein the machine learning model comprises one of: a neural network, a logistic regression model, a support vector machine (SVM), or a decision tree or random forest model.

7. The method of claim 1, wherein generating the neighborhood feature vector for the new data object comprises determining a concatenation of respective similarity scores of a subset of the N neighbor data objects having a particular category among the respective categories defined by their one or more labels.

8. The method of claim 7, wherein the subset of the N neighbor data objects include neighbor data objects that each have a positive label that defines a trusted category.

9. The method of claim 7, wherein the subset of the N neighbor data objects include neighbor data objects that each have a negative label that defines a non-trusted category.

10. The method of claim 1, wherein each data object represents an image, video, an audio, text, or a web page.

11. The method of claim 1, wherein a value of N is dependent on a total number of the labels that each reference data object has.

12. A system comprising one or more computers and one or more storage devices storing instructions that when executed by the one or more computers cause the one or more computers to perform operations comprising:
maintaining a dataset comprising a plurality of reference data objects that each have one or more labels, one or more features, or both, wherein each label for a reference data object defines a respective category of the reference data object and each feature for the reference data object describes a characteristic of the reference data object;
receiving a request to add, to the dataset, a new data object that (i) has one or more features but (ii) is missing one or more labels;
selecting, from the plurality of reference data objects, N neighbor data objects based on similarity scores of the neighbor data objects with respect to the new data object, wherein the similarity score for each neighbor data object is determined based on the one or more features of the new data object and the one or more features of the neighbor data object, where Nis a natural number equal to or greater than one;
generating a neighborhood feature vector for the new data object using, for each neighbor data object in the N neighbor data objects, (i) the one or more labels of the neighbor data object and (ii) the similarity score of the neighbor data to the new data object;
processing the neighborhood feature vector using a machine learning model to predict the one or more labels that are missing for the new data object; and
updating the dataset to include the new data object and to associate the one or more predicted labels with the new data object.

13. The system of claim 12, wherein maintaining the dataset comprising a plurality of reference data objects comprises maintaining data describing a heterogeneous graph comprising a plurality of nodes connected by edges, each node corresponding to a different one of the reference data objects in the plurality of reference data objects, each edge representing a relationship between two nodes connected by the edge.

14. The system of claim 12, wherein maintaining the dataset comprising a plurality of reference data objects comprises maintaining the plurality of reference data objects and their associated labels and features in a relational dataset.

15. The system of claim 12, wherein the operations comprise determining the similarity score for each neighbor data object with respect to the new data object based on one of: Euclidean distance or cosine similarity in an embedding space.

16. The system of claim 12, wherein the operations comprise determining the similarity score for each neighbor data object with respect to the new data object based on one of: a pointwise mutual information (PMI) score or a bipartite score.

17. The system of claim 12, wherein the machine learning model comprises one of: a neural network, a logistic regression model, a support vector machine (SVM), or a decision tree or random forest model.

18. The system of claim 12, wherein generating the neighborhood feature vector for the new data object comprises determining a concatenation of respective similarity scores of a subset of the N neighbor data objects having a particular category among the respective categories defined by their one or more labels.

19. The system of claim 12, wherein each data object represents an image, video, an audio, text, or a web page.

20. A non-transitory computer storage medium encoded with a computer program, the computer program comprising instructions that when executed by one or more computers cause the one or more computers to perform operations comprising:
maintaining a dataset comprising a plurality of reference data objects that each have one or more labels, one or more features, or both, wherein each label for a reference data object defines a respective category of the reference data object and each feature for the reference data object describes a characteristic of the reference data object;
receiving a request to add, to the dataset, a new data object that (i) has one or more features but (ii) is missing one or more labels;
selecting, from the plurality of reference data objects, N neighbor data objects based on similarity scores of the neighbor data objects with respect to the new data object, wherein the similarity score for each neighbor data object is determined based on the one or more features of the new data object and the one or more features of the neighbor data object, where Nis a natural number equal to or greater than one;
generating a neighborhood feature vector for the new data object using, for each neighbor data object in the N neighbor data objects, (i) the one or more labels of the neighbor data object and (ii) the similarity score of the neighbor data to the new data object;
processing the neighborhood feature vector using a machine learning model to predict the one or more labels that are missing for the new data object; and
updating the dataset to include the new data object and to associate the one or more predicted labels with the new data object.
